(19) United States
(12) Patent Application Publication
(10) Pub. No.: US 2016/0169839 A1
(43) Pub. Date: Jun. 16, 2016

(54) Ultrasonic Rag Layer Detection System And Method For Its Use

(71) Applicant: Cameron International Corporation, Houston, TX (US)

(72) Inventors: Emanuel Gottlieb, Pittsburgh, PA (US); Donald Augenstein, Pittsburgh, PA (US); Gary W. Sams, Spring, TX (US)

(21) Appl. No.: 14/567,944

(22) Filed: Dec. 11, 2014

(51) Int. Cl. G01N 29/02; G01N 29/26; G01N 29/36

(52) U.S. Cl. CPC G01N 29/02; G01N 29/36; G01N 29/26; G01N 2291/106; G01N 2291/0224

(57) ABSTRACT

A system and method for detecting and locating the interface emulsion or rag layer in a separator vessel makes use of an acoustic property approach or an imaging approach. Both approaches use ranging and longitudinal mode reflectance and are non-ionizing. The signals are sent through the fluid medium residing in different zones of the vessel, not through the vessel wall or a probe surrounded by the fluid medium. The acoustic property approach uses differences in acoustic impedance between the oil, rag, and water layers that create an echo detected by transit time measurement. Also, the velocity of sound, density, viscosity and attenuation can be calculated for each fluid in order to determine whether the medium is oil, rag, or water. The imaging approach uses differences in amplitude reflectance at these interfaces to create a brightness mode image of the different layers by each amplitude mode scan line being added spatially.

### BACKGROUND OF THE INVENTION

This invention relates to systems and methods used to detect an interface emulsion or rag layer within a separator vessel. More specifically, the invention relates to non-radioactive-based, ultrasonic technologies using longitudinal waves to detect the interface emulsion or rag layer and determine its location and depth.

The basic method of separating a mixture of oil and water is by use of gravity. For this purpose, separators are frequently employed at the point where the crude oil first reaches the earth's surface. These separators range from rather unsophisticated holding vessels—which simply provide an enclosed container wherein the oil-and-water mixture can rest with reduced turbulence, thereby allowing the oil to float to an upper part of the vessel and water to settle to a lower part of the vessel—to more sophisticated vessels that apply desalting and dehydration methods. The goal is to produce a stabilized crude oil with basic sediment and water content typically in a range of 0.1 to 1.0% by volume, which can usually be accomplished by advanced separation technologies.

Regardless of the type of vessel used for separation—gravity or electrostatic—it is common for oil-coated solids (“mud”) to accumulate in the bottom of the vessel and for a solid-laden mixture of oil and water (“emulsion” or “rag”) to form at the oil-and-water interface. For the purpose of this disclosure this emulsion or rag is mixture of sands, froths, water and dispersed oil that forms between an oil layer and a water layer within a separator vessel and has a density that is a volume fraction between the oil and the water (e.g., less than 1 and residing on top of the water layer).

The content and volume of the rag layer is an important factor in overall separator performance. The layer, if left uncontrolled, can affect electrostatics, reduce the effect of dewatering processes, and increase the cost of maintaining the separator vessel and downstream equipment. For example, the layer can grow in height until it interferes with the integrity of the electrostatic field, increasing the current demand and reducing the field strength. If the layer sinks into the water layer, it rapidly occupies the water volume of the vessel, reduces the water residence time, and causes a decline in water quality being passed to downstream water treatment facilities. If portions of the layer settle to the bottom of the vessel to form mud, it can mix with exiting brine and accelerate the fouling and plugging of downstream heat exchangers and benzene recovery units. As production of heavier crude or synthetic crude increases, the layer also can affect the recovery of bitumen.

The mitigation and reduction of the rag layer in separator vessels is an important subject for oil production and separator operation. Determining where the layer is, and the height of the layer in, the vessel helps operators, for example, maximize bitumen extraction and allow for adequate dissolvers to be added. In order to assess the effectiveness of any rag layer reduction technique, a way of measuring the layer is beneficial because it provides essential feedback to separator controls.

Various devices and systems have been proposed to measure fluid or liquid levels in separator vessels (see Mahmoud Meribout et al., Interface Layers Detection in Oil Field Tanks: A Critical Review, in Expert Systems for Human Materials and Automation (PreticÄf Vizureanu, ed.; Intech, 2011) and hereby incorporated by reference) (“Meribout”). The most common device is a vertical array of displacers or floats located within the vessel. The sensors are adjusted for a certain specific density but the floats can experience material build up which affects their displacement. Additionally, fluids within the vessel can experience changes in density due to variations in temperature, leading to measurement error.

Other devices for measuring fluid levels are differential pressure-based and make use of an array of pressure sensors arranged vertically within the vessel. These pressure sensor-based methods require the use of extremely low sensitivity sensors and, like the floats, are subject to material build-up problems leading to measurement error and maintenance issues.

Still other devices make use of a vertical array of vibrating probes or paddles that get dampened when covered by a fluid. A magnet and reed switch combination is used to detect the amount of dampening. These devices require a lot of power to drive the sensors, turbulence within the vessel can cause measurement errors, and the device is sensitive to material build up. Material build up is also an issue with devices that make use of optical fiber sensors.

Other devices make use of electronic techniques such as capacitance sensing using radio frequency technology or impedance spectrometry with capacitance sensing, a vertical array of capacitance sensors can be immersed in the fluid and the change in capacitance can be measured between an electrode and the vessel wall (or some other reference plate within the vessel). Other examples include a sensor immersed in the fluid and sweeping a first frequency range, and a voltage detector connected to the sensor providing a second electrical signal that varies according to the various electrical impedances encountered.

Still other devices make use of radar or microwaves. A microwave generator transmits a signal and the height of the liquid is determined by considering the distance between the transmitter and the ground, the transmit time of the echoes, and the speed of the microwaves. The sensors are not intrusive but water residing at the bottom of the vessel absorbs most of the energy, making detection of the emulsion layer difficult.

Other devices make use of radiation-based instruments and radioisotopes such as those from Gamma sources. The radiation from the source penetrates the vessel wall and the fluid within the vessel. A vertical array of radiation sensors are then used to measure the density profile of the fluid. While highly accurate and able to withstand harsh environments, cost and safety are issues.

Last, some devices make use of ultrasound waves to locate the interface between fluids residing within a vessel (see e.g. U.S. Pat. No. 4,320,659 to Lynnworth et al.) (“Lynnworth”) and Meribout (disclosing an ultrasonic-based device that isolates a vertical column of the fluid using an insertable and removable transducer ladder arrangement with reflectors)). Lynnworth uses shear mode reflectance to measure impedance differences between the vessel itself and the fluid at the pressure boundary. Transducers attached at an oblique angle to the exterior of the vessel generate an interrogating beam that traverses along a zig path within the vessel wall or through probes immersed in the fluids (with the shear wave being unable to travel to the fluid medium). The ratio of sequential attenuated amplitudes of the signal waveform corresponds to a measure of the impedance or an impedance-related parameter of the fluid. A second acoustic path serves as a reference to correct for temperature changes and material buildup along the probe. To detect the fluid level without use of intrusive probes, the systems require various zigzag interrogation path locations and orientations and this complicated arrangement is unsuitable for easily determining the location of two or more fluids in the vessel. This technique, which does not make use of ranging, is only feasible at the interface between boundaries—e.g., pipe wall/transducer/fluid interface—and not any distance from that boundary.

Ultrasonic-based systems are attractive because of their potential for low cost and maintenance requirements and their high accuracy and safety. Currently, the only commercially effective rag layer measuring systems are ones that use radioactive sources. Radioactive based technologies are difficult to convince operators to adopt because of safety concerns. Therefore, a need exists for a non-intrusive ultrasonic-based system for determining the location and height of a rag layer within a separator vessel.

### SUMMARY OF THE INVENTION

Systems and methods made according to this invention for detecting and locating the interface emulsion or rag layer in a separator vessel makes use of an acoustic property approach or an imaging approach. Both approaches use ranging (pulse echo) and longitudinal (not shear) mode reflectance and are non-ionizing. The signals are sent through the fluid medium and not through the vessel wall or a probe surrounded by the fluid medium.

The acoustic property approach relies upon differences in acoustic impedance between the oil, rag, and water layers that create an echo detected by transit time measurement. Also, the velocity of sound, density, viscosity and attenuation can be calculated for each fluid in order to determine whether the medium is oil, rag, or water. The imaging approach employs differences in amplitude reflectance at these interfaces to create a brightness mode image of the different layers by each amplitude mode scan line being added spatially.

A separator vessel is equipped with a plurality of transducer elements located at predetermined locations on the separator vessel to query fluid medium residing in different zones of the separator vessel. The individual transducer elements, which can be arranged in pitch-and-catch relationship (in the acoustic property approach) or as a phased array (in the imaging approach), are arranged oblique to a central longitudinal axis of the separator vessel. The transducer elements send a longitudinal wave at an ultrasonic frequency through the fluid medium and the pulse echo time or the reflected amplitude of the wave is measured. The measurements are then used to determine the type of fluid medium residing within the different zones and identify the location and depth of the interface emulsion or rag layer. Regression analysis may be used to calculate density (lbs/gal or kg/m3) or viscosity (cP or cSt) of the fluid medium (e.g., oil, water, or rag) from acoustic parameters such as frequency (MHz), gain (dB), and velocity of sound (m/s).

In a preferred embodiment, the system includes a separator vessel equipped with a plurality of transducers oriented at a non-oblique angle relative to a central longitudinal axis of the separator vessel. A first transducer sends a first signal at an ultrasonic frequency across a first reference distance d₅, of a water-dominant portion of the separator vessel. A second transducer sends a second signal at an ultrasonic frequency across a second reference distance d₅, of an oil-dominant portion of the separator vessel. A third transducer sends a third signal at an ultrasonic frequency vertically upward through the water-dominant portion of the separator vessel and toward an interface emulsion layer. A fourth transducer sends a fourth signal at an ultrasonic frequency vertically downward through the oil-dominant portion of the separator vessel and toward an interface emulsion layer.

The signals are preferably transmitted in a range of 40 kHz to 5 MHz. The first signal provides a transit time t₅ across the first reference distance d₅ and is used in combination with the first reference distance d₅ to calculate a speed of sound c₁ through the water-dominant portion of the separator vessel. The second signal provides a transit time t₆ of the second signal across the first reference distance d₅ and is used in combination with the first reference distance d₅ to a calculate a speed of sound c₂ through the oil-dominant portion of the separator vessel. The third signal provides a pulse-echo transit time t₁ of the third signal and is used in combination with the speed of sound c₁ to calculate a distance d₁ to a lowermost end of the interface emulsion layer. The fourth signal provides a pulse-echo transit time t₂ of the fourth signal and is used in combination with the speed of sound c₂ to calculate a distance d₂ to an uppermost end of the interface emulsion layer. The height d₃ of the interface emulsion layer residing between the water-and oil-dominant portions is calculated using a second reference distance d₄ and the distances d₁ and d₂.

A method which makes use of the above system includes the steps of:
sending a first signal at an ultrasonic frequency across a first reference distance d₅, of a water-dominant portion of the separator vessel, measuring a transit time t₅ of the first signal across the first reference distance d₅; and calculating, using the first reference distance d₅ and the transit time, t₅ a speed of sound c₁ through the water-dominant portion of the separator vessel;
sending a second signal at an ultrasonic frequency across a second reference distance d₅ of an oil-dominant portion of the separator vessel, measuring a transit time t₆ of the second signal across the first reference distance d₅; and calculating, using the first reference distance d₅ and the transit time t₆ a speed of sound c₁ through the oil-dominant portion of the separator vessel;
sending a third signal at an ultrasonic frequency vertically upward through the water-dominant portion of the separator vessel and toward an interface emulsion layer, measuring a pulse-echo transit time, t₁, of the third signal; and calculating, using the pulse-echo transit time t₁ and the speed of sound c₁, a distance, d₁ to a lowermost end of the interface emulsion layer;
sending a fourth signal at an ultrasonic frequency vertically downward through the oil-dominant portion of the separator vessel and toward an interface emulsion layer, measuring a pulse-echo transit time, t₂, of the fourth signal, and calculating, using the pulse-echo transit time t₂ and the speed of sound c₁, a distance d₁ to a lowermost end of the interface emulsion layer; and
calculating a height d₃ of the interface emulsion layer residing between the water-and oil-dominant portions using a second reference distance d₄ and the distances d₁ and d₂.

The separator vessel can be a vertically oriented vessel, with the first and second transducers being oriented perpendicular to a central longitudinal axis of the vessel and the third and fourth transducers being oriented parallel to the central longitudinal axis of the vessel. Alternatively, the separator vessel can be a horizontally oriented vessel, with the first and second transducers being oriented parallel to a central longitudinal axis of the vessel and the third and fourth transducers being oriented perpendicular to the central longitudinal axis of the vessel.

In another preferred embodiment, the system includes a plurality of transducers oriented at a non-oblique angle to a central longitudinal axis of the separator vessel and arranged at a vertical level L to send a signal at a predetermined ultrasonic frequency f_{L} and gain g_{L} across a horizontal reference distance d_{L} of the separator vessel. Preferably, the frequency is in a range of 40 kHz to 5 MHz. A first transducer of the plurality is located at a vertical level L₁ to send a first signal across a first horizontal reference distance d₁ of the separator vessel. At least one second transducer of the plurality is located at a vertical level L₂, L₂>L₁, to send a second signal across a second horizontal reference distance d₂. A third transducer of the plurality is located at a vertical level L₃, L₃>L₂, to send a third signal across a third horizontal reference distance d₃ of an upper portion of the separator vessel. Preferably, level L₁ is located in a lower third of the separator vessel and the vertical level L₃ is located in an upper third of the separator vessel.

The first signal provides a transit time t₁ across the first horizontal reference distance d₁ and is used in combination with the first horizontal reference distance d₁ to calculate a speed of sound c₁ through a fluid medium residing within the separator vessel at vertical level L₁. The second signal provides a transit time t₂ of the second signal across the second horizontal reference distance d₂ and is used in combination with the second horizontal reference distance d₂ to a calculate a speed of sound c₂ through a fluid medium residing within the separator vessel at vertical level L₂. The third signal provides a transit time t₃ of the third signal across the third horizontal reference distance d₃ and is used in combination with the third horizontal reference distance d₃ to calculate a speed of sound c₃ through a fluid medium residing within the separator vessel at vertical level L₁. For a respective vertical level L_{L}, at least one of the calculated speeds of sound c_{L}, frequency f_{L}, and gain g_{L} are used in a regression equation to determine a density and a viscosity of the fluid medium residing at vertical level L, the density and viscosity of the interface emulsion layer being between that of an oil-dominant and a water-dominant portion of the separator vessel.

A method which makes use of the above system includes the steps of:
sending a first signal at a vertical level L₁ across a first horizontal reference distance d₁ of the separator vessel, measuring a transit time t₁ of the first signal across the first horizontal reference distance d₁, and calculating, using the transit time t₁ and the first horizontal reference distance d₁, a speed of sound c₁ through a fluid medium residing within the separator vessel at vertical level L₁;
sending a second signal at a vertical level L₂, L₂>L₁, across a second horizontal reference distance d₂, measuring a transit time t₂ of the first signal across the first horizontal reference distance d₂, and calculating, using the transit time t₂ and the first horizontal reference distance d₂, a speed of sound c₂ through a fluid medium residing within the separator vessel at vertical level L₂;
sending a third signal at a vertical level L₃, L₃>L₂, across a third horizontal reference distance d₃ of the separator vessel, measuring a transit time t₃ of the first signal across the first horizontal reference distance d₃, and calculating, using the transit time t₃ and the first horizontal reference distance d₃, a speed of sound c₃ through a fluid medium residing within the separator vessel at vertical level L₃;
   For a respective vertical level L, at least one of the calculated speeds of sound c_{L}, frequency f_{L}, and gain g_{L} are used in a regression equation to determine a density and a viscosity of the fluid medium residing at vertical level L, the density and viscosity of the interface emulsion layer being between that of an oil-dominant and a water-dominant portion of the separator vessel.

In yet another embodiment of the invention, the system includes a phased array located at a top or bottom side of the separator vessel, the phased array including a plurality of spaced-apart individual transducer elements. Each individual transducer element emits an ultrasonic signal at a different predetermined time delay per angle within a field of view of the phased array. Preferably, the frequency of the ultrasonic signal is in a range of 40 kHz to 5 MHz and the field of view is 120°. The ultrasonic signal is reflected as it encounters an interface between fluid mediums residing within the separator vessel, and the reflectance amplitude of the ultrasonic signal is converted to a brightness image. A brightness image of the interface emulsion layer is different than that of an oil-dominant and a water-dominant layer.

A method which makes use of the above system includes the steps of:
sending from the individual transducer elements an ultrasonic signal at a predetermined angle φ, the sending step occurring at a different time t for each individual transducer element;
measuring for each respective individual transducer element an amplitude of a reflected signal at a water-rag interface and at a rag-oil interface
incrementing the predetermined angle φ through a field of view of the phased array and for each incremented predetermined angle φ repeating the sending and measuring steps; and
converting the measured amplitudes of the reflected signals into a brightness image, which can then be displayed to an operator.
   The sending step for the individual transducer element is delayed sequentially for the original or incremented predetermined angle φ by τₙ=(n−1)×Δ, where Δ is a time delay as a function of the angle φ and n corresponds to an order of an individual transducer element in the phased array, n ranging from 1 (the first transducer element of the phased array) to the total number of individual transducer elements in the phased array.

The method can include the step of measuring a visual separation of at least one of the oil, rag, and water layers. Means such as digital calipers can be used to accomplish this step. As the brightness image continues to be regenerated, real-time depletion of the rag layer can be seen by an operator after chemical solvents have been added to the separator vessel.

Objectives of this invention include providing a system and method for detecting and measuring an interface emulsion or rag layer that (1) is non-ionizing; (2) is non-intrusive and, therefore, less likely to be affected by material building up; (3) uses ranging; (4) uses longitudinal waves; and (5) can be installed as a permanent fixture on a separator vessel.

### BRIEF DESCRIPTION OF THE DRAWINGS

FIG. 1 is a schematic of a separator vessel outfitted with transducers located at predetermined locations around the vessel to transmit and receive signals either horizontally across the oil or water layer or vertically through the oil, rag, and water layers.

FIG. 2 is a schematic of a separator vessel outfitted transducers that send and receive ultrasonic signals across the fluid at various predetermined heights or levels.

FIG. 3 is a schematic of a phased array transducer to determine crude oil, rag, and water interfaces using an imaging approach.

FIG. 4 is a schematic of a separator vessel outfitted with the phased array transducer of FIG. 3.

FIG. 5 is a schematic of a brightness image derived from the phased array transducer measurements.

FIG. 6 is an example screen shot of the reflectance at the interfaces detected by the phased array of FIGS. 3 and 4 being converted into brightness mode images so the layers of the fluid can be visually detected in real time.

### ELEMENT NUMBER AND ELEMENTS USED IN THE DRAWINGS

10 Acoustic property-based system

11 First set of horizontally oriented transducers

13 Second set of horizontally oriented transducers

15 Lowermost vertically oriented transducer

17 Uppermost vertically oriented transducer

20 Acoustic property based sampling system

21 Set of transducers at first vertical level, L₁

22 Set of transducers at second vertical level, L₂

23 Set of transducers at third vertical level, L₃

24 Set of transducers at fourth vertical level, L₄

25 Set of transducers at fifth vertical level, L₅

40 Image-based system

41 Phased array

43 Individual transducer element

60 Separator vessel

61 Lower region or lower third

63 Upper region or upper third

65 Lowermost or bottom end

67 Uppermost or top end

70 Water-dominant portion of 60

80 Interface emulsion or rag layer

81 Lowermost end or boundary (the water-rag interface)

83 Uppermost end or boundary (the rag-oil or oil-rag interface)

90 Oil-dominant portion of 60

d₁ Height of the water layer

d₂ Height of the oil layer

d₃ Height of the interface emulsion or rag layer

d₄ Reference height of 60

d₅ Reference width of 60

### DETAILED DESCRIPTION OF THE PREFERRED EMBODIMENTS

A system and method for detecting and locating the interface emulsion or rag layer in a separator vessel makes use of an acoustic property approach or an imaging approach. Both approaches make use of ranging (pulse echo) and longitudinal (not shear) mode reflectance and are non-ionizing. The signals are sent through the fluid medium and not through the vessel wall or a probe surrounded by the fluid medium.

The acoustic property approach relies upon differences in acoustic impedance between the oil, rag, and water layers that create an echo detected by transit time measurement. Also, the velocity of sound, density, viscosity and attenuation can be calculated for each fluid in order to determine whether the medium is oil, rag, or water. The imaging approach employs differences in amplitude reflectance at these interfaces to create a brightness mode image of the different layers by each amplitude mode scan line being added spatially.

A separator vessel is equipped with a plurality of transducer elements located at predetermined locations on the separator vessel to query fluid medium residing in different zones of the separator vessel. The individual transducer elements, which can be arranged in pitch-and-catch relationship (in the acoustic property approach) or as a phased array (in the imaging approach), are arranged oblique to a central longitudinal axis of the separator vessel. The transducer elements send a longitudinal wave at an ultrasonic frequency through the fluid medium and the pulse echo time or the reflected amplitude of the wave is measured. The measurements are then used to determine the type of fluid medium residing within the different zones and identify the location and depth of the interface emulsion or rag layer.

Because both approaches make use of ultrasonic devices which are non-intrusive but permanent parts of the separator vessel, the approaches are believed to provide a lower cost relative to current detection methods, provide better accuracy (resolution is approximately the wavelength), require little to no maintenance because of no moving parts, and are non-ionizing because no radiation source is involved. The embodiments described for each approach are exemplary and, as such, may not encompass all possible embodiments of the invention. The invention is defined by the claims which follow those descriptions.

### Acoustic Property Approach

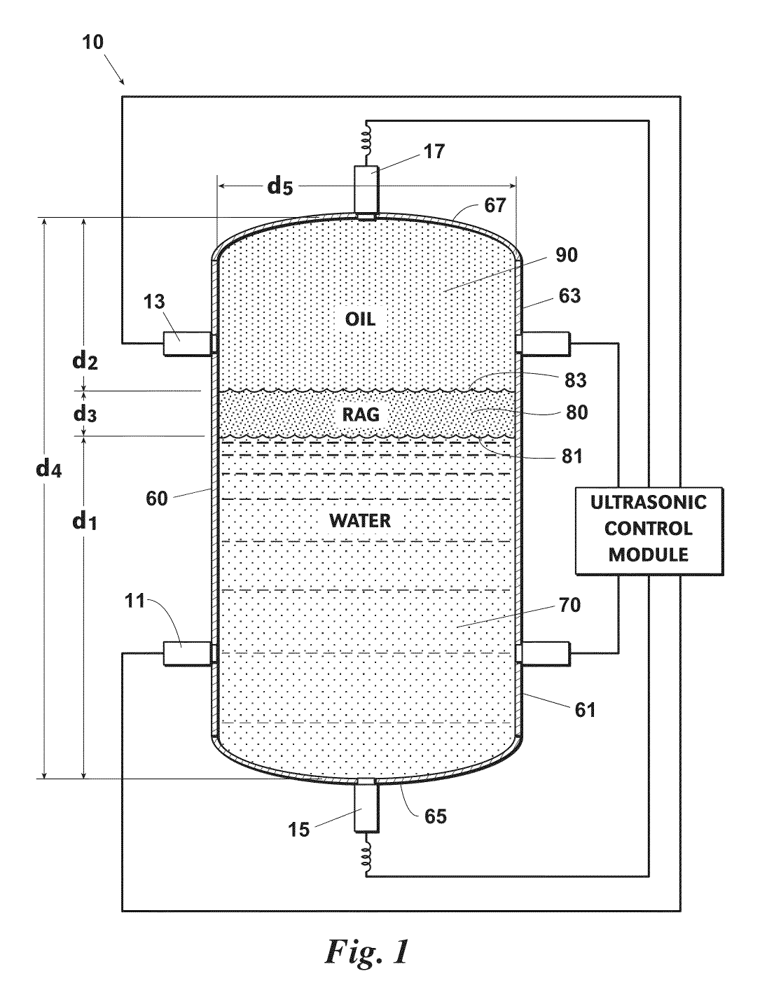

Referring first to FIG. 1, in one preferred embodiment of this approach, an acoustic property-based system 10 has transducers located at predetermined locations around the vessel to transmit and receive signals either horizontally across the oil or water layer or vertically through the oil, rag, and water layers as described below.

A first set of transducers 11, which are preferably arranged in pitch-and-catch horizontal relationship, transmits and receives an ultrasonic signal across a lower region 61 of a separator vessel 60 where a portion of the water-dominant layer 70 is known to reside. The transit time, t₅, of the signal across the vessel 60 is measured. The speed of sound c₁ in the water-dominant layer 70 is calculated using the known reference width d₅ of the vessel 60 divided by the transit time, t₅:

$${c}_{1} = \frac{{d}_{5}}{{t}_{5}} \qquad ( Eq . 1 )$$

A second set of transducers 13, which are preferably arranged in pitch-and-catch horizontal relationship, transmits and receives an ultrasonic signal across an upper region 63 of the vessel 60 where a portion of the oil-dominant layer 90 is known to reside. The transit time t₆ of the signal across the vessel 60 is measured. The speed of sound c2 in the oil-dominant layer 90 is calculated by dividing the known reference width d₅ (in meters) of the vessel 60 by the transit time t₆ (in seconds):

$${c}_{2} = \frac{{d}_{5}}{{t}_{6}} \qquad ( Eq . 2 )$$

Another transducer 15, located at the lowermost or bottom end 65 of the vessel 60, transmits a signal vertically upward which is then reflected back by the lowermost end or boundary 81 of the rag layer 80. The vertical path d₁ of the length in the water-dominant layer 70 is calculated by multiplying the calculated speed of sound c₁ by the pulse echo transit time t₁ and dividing the product by 2:

$${d}_{1} = \frac{{c}_{1} {t}_{1}}{2} \qquad ( Eq . 3 )$$

Another transducer 17, located at the uppermost or top end 67 of the vessel 60, transmits a signal vertically downward which is reflected back from the uppermost end or boundary 83 of the rag layer 80. The vertical path d₂ of the length in the oil-dominant layer 90 is calculated by multiplying the calculated speed of sound c₂ by the pulse echo transit time t₂ and dividing the product by 2:

$${d}_{2} = \frac{{c}_{2} {t}_{2}}{2} \qquad ( Eq . 4 )$$

The height d₃ of the rag layer 80 can then be calculated by subtracting the vertical paths d₁ and d₂ (which represent the heights of the water-dominant and oil-dominant layers 70, 90 respectively) from the known reference height d₄ of the vessel 60:

d₃=d₄−d₁−d₂ (Eq. 5)

The exact location of the uppermost end 83 of the rag layer 80 relative to the lowermost end 65 of the vessel 60 is the sum of d₁ and d₃ or, conversely, d₄ minus d₂. The exact location of the lowermost end 83 of the rag layer 80 relative to the lowermost end 65 of the vessel 60 is d₁ or, alternatively, d₄ minus d₂ and d₃.

One or more sets of the pitch-and-catch-arranged transducers 11, 13 could be replaced by a single transducer which uses the vessel wall opposite it to reflect the signal. In this alternate arrangement, the pulse echo equation is used to calculate the speed of sound through the respective fluid medium. Additionally, the transducers 15, 17 located at the lowermost and uppermost ends 65, 67 of the vessel could be horizontally offset from one another. Regardless of the transducer arrangement used, each transducer preferably has a pressure barrier of kind well known in the art located between it and the housing to isolate the transducers from the fluids.

Instead of being oriented at an oblique angle to a central longitudinal axis of the vessel, the transducers in this and other embodiments are oriented either perpendicular to or parallel to the central longitudinal axis depending on the vessel's major orientation (horizontal or vertical) and whether the transducer is located on a side of the vessel or at top or bottom end.

The preferred frequency used in this embodiment, and in the other preferred embodiments, is in a range of 40 kHz to 5 MHz. For a particular separator application, routine experimentation is required to find the best balance between the required signal travel distance and desired resolution.

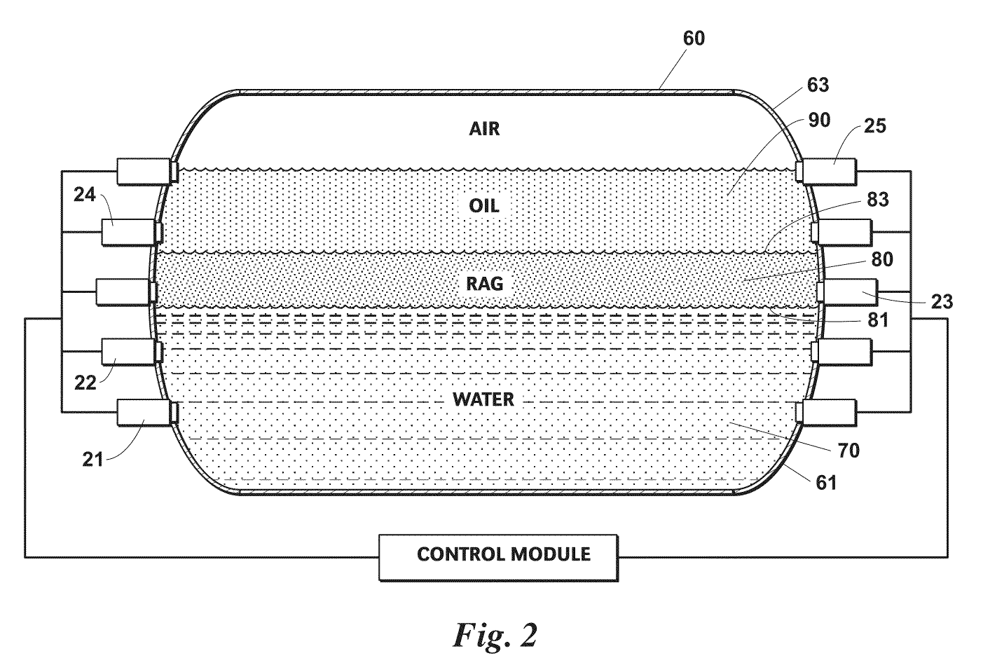

Referring now to FIG. 2, in another embodiment of the acoustic property approach, sampling system 20 uses sets or pairs of transducers 21-25 arranged in pitch-and-catch relationship on opposite sides of the separator vessel 60 at predetermined vertical heights or levels L (e.g. 1, 2, . . . 5). Each set 21-25 transmits and receives signals horizontally across the vessel 60 and, therefore, sample a respective air, oil, rag, or water layer. The number of levels L sampled is a matter of design choice, but at least five levels appears to be a reasonable number. The sets 21-25 could be replaced by a single transducers with pulse echo being relied upon to calculate the speed of sound through the fluid medium residing at each level L.

At each height or level L, the transit time (t_{L}), gain (dB), and frequency, f (MHz) are measured. For example, the transmission frequency, f, will attenuate in a range of about 1 to 10% depending on whether the fluid medium is oil, rag, or water. Similarly, sound attenuation occurs depending on the medium, thereby affecting the gain required when generating the signal.

The velocity of sound, c_{L}, through the fluid medium is then calculated:

$${c}_{L} = \frac{{d}_{L}}{{t}_{L}} \qquad ( Eq . 6 )$$

where L is the level corresponding to the respective transducers (e.g. 1, 2, . . . , N), t_{L} is the transit time at level L, and d_{L} is the reference pipe (vessel 60) width at the level L.

For a particular separator application, samples of the oil and water mediums are collected and the density, ρ, and viscosity, υ, of each fluid medium is determined. (The value for clean water is known but the values for water with contaminants may be different.) Regression analysis may be used to calculate density (lbs/gal or kg/m3) or viscosity (cP or cSt) of the fluid medium (e.g., oil, water, or rag) from acoustic parameters such as frequency (MHz), gain (dB), and velocity of sound (m/s).

Using regression analysis, an equation can be developed for density, ρ, and for viscosity, υ, of the oil and water as a function of the speed of sound (c), gain, and frequency (freq.):

F(ρ,υ)=(C₁×c)+(C₂×Gain)+(C₃×freq.) (Eq. 7)

where c is a calculated value from the measured transit time and known distance separation between transducers. Gain and frequency are measured values, and C₁, C₂ and C₃ are relative weightings (i.e. regression coefficients) determined by the regression analysis.

The regression equation can then be used with the calculated value of the speed of sound at each level, along with the measured gain and frequency associated with the level, to calculate the density and viscosity at that level:

F(ρ,υ)_{L}=(C₁×c_{L})+(C₂×Gain_{L})+(C₃×freq._{L}) (Eq. 8)

The results can be compared to known values for the oil and water mediums to determine the location of the rag layer 80 and its boundaries 81, 83.

### Imaging Approach

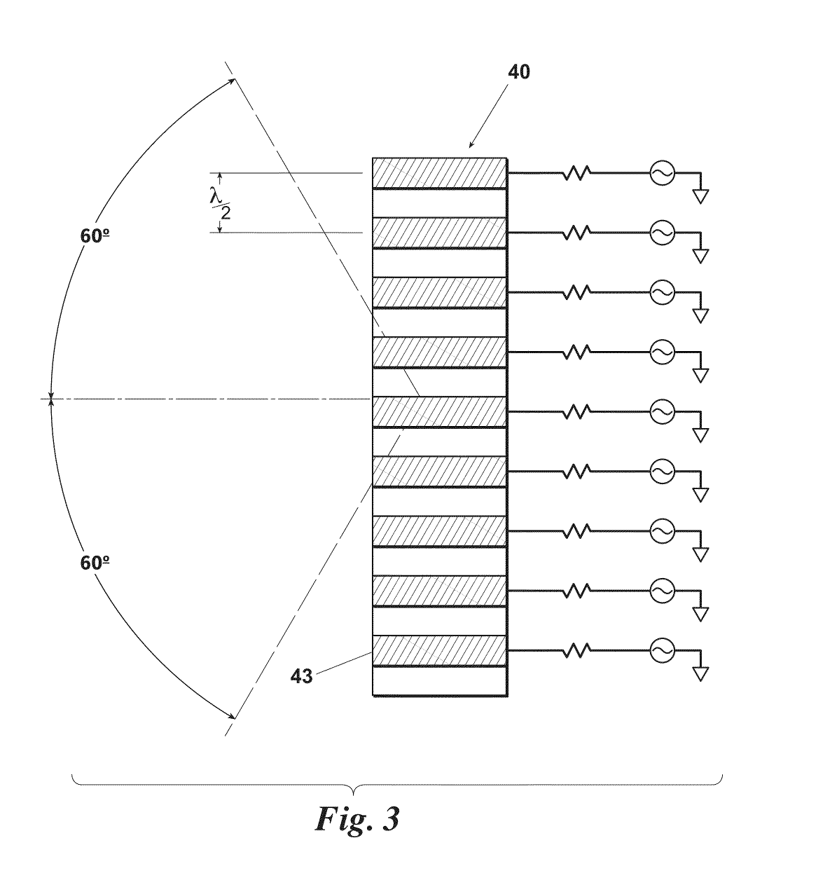

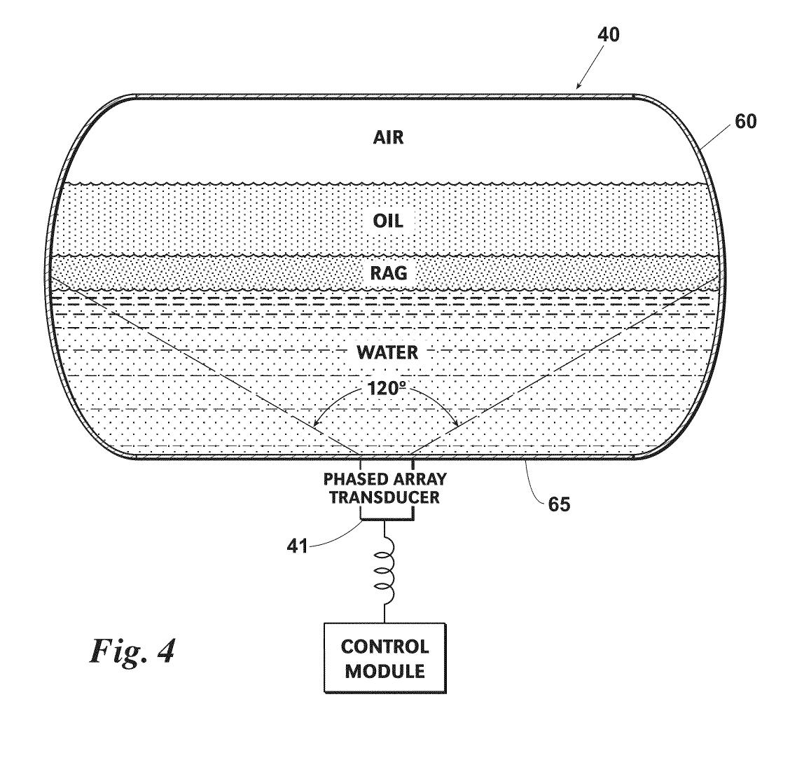

Referring now to FIGS. 3 and 4, the image-based system 40 uses a phased array transducer 41 located on a bottom end 65 of the separator vessel 60 to determine crude oil, rag, and water layer interfaces. Alternatively, the phased array 41 can be located at the upper end 67 of the vessel 60. The phased array 41 includes a multitude of individual transducer elements 43, the width of which is the size of one wave length (see FIG. 3). The array 41 generates and directs an ultrasonic beam which is steered through a field of view. The field of view is preferably a 120° field of view.

As the beam is steered through the field of view, small time delays are used for transmit focusing periods. The sweep at each subsequent angle φ is time delayed from the previous sweep as follows:

$$Time delay Δ = \frac{sin φ}{2 f} \qquad ( Eq . 9 )$$

At φ=0°, there is no time delay. Once the time delay is calculated for a given angle φ, each element is delayed sequentially as follows:

τₙ=(n−1)×Time delay Δ (Eq. 10)

where n is the sequential order number of a transducer element 43 in the array 41 (e.g., n=1 for the first transducer element and n=N for the last transducer element 43, N being the total or maximum number of transducer elements in the array). All elements 43 send at the same angle φ with a time delay and the received signals then form one scan line per angle (e.g., 120 scan lines to make up the image).

At each angle φ, the transmitted signal is reflected at the water-rag, rag-oil, and oil-air interfaces. The pulse echo transit time and the peak-to-peak amplitude of the reflected signal at each interface are measured. By way of example, the acoustic impedance for oil, Zₒᵢₗ, and water, Z_{water}, is:

Zₒᵢₗ=ρ×c=825 (kg/m³)×1290 (m/s)=1.070 MRyals (Eq. 11)

Z_{water}=ρ×c=1000 (kg/m³)×1483 (m/s)=1.483 MRyals (Eq. 12)

The reflectance, R, at the water-oil interface is:

$$R = \frac{{P}_{R}}{{P}_{i}} = \frac{{Z}_{water} - {Z}_{oil}}{{Z}_{water} + {Z}_{oil}} \times 100 = 16.18 \% \qquad ( Eq . 13 )$$

The reflectance, R, is the ratio of reflected pressure received by the transducer divided by the incident pressured transmitted by the transducer, therefore, the signal being returned from the water-oil interface is about 16% of what was sent.

Beam steering techniques well known in the field of acoustics, and signal processing techniques such as dynamic receive focusing well known in that field, are used to transmit and then process the received signals (see e.g. the following references which are hereby incorporated by reference: Lawrence E. Kinsler et al., Reflection and Transmission, in Fundamentals of Acoustics Ch. 6 (4th ed., Wiley, 1999); Kai. E. Thomenius, Evolution of Ultrasound Beamformers, IEEE Ultrasonics Symposium 1615 (IEEE, 1996); Olaf. T. Von Ramm & Stephen W. Smith, Beam Steering with Linear Arrays, IEEE Transactions on Biomedical Engineering 438, Vol. BME-30, No. 8 (August 1983)). For example, in dynamic receive focusing the channel signals are delayed and, after this delay, the outputs from the received channels are summed and processed to obtain a scan line brightness image. The delay in the channels is then altered to produce a new focal region along the scan line and the receive function is repeated until all echoes from the most distant focal region have been received. A new pulse is then transmitted in a different direction (i.e., a new scan line) and the dynamic receive function repeats. This transmit and dynamic receive process continues throughout the field of view to provide a complete brightness image of the fluid mediums and their respective interfaces.

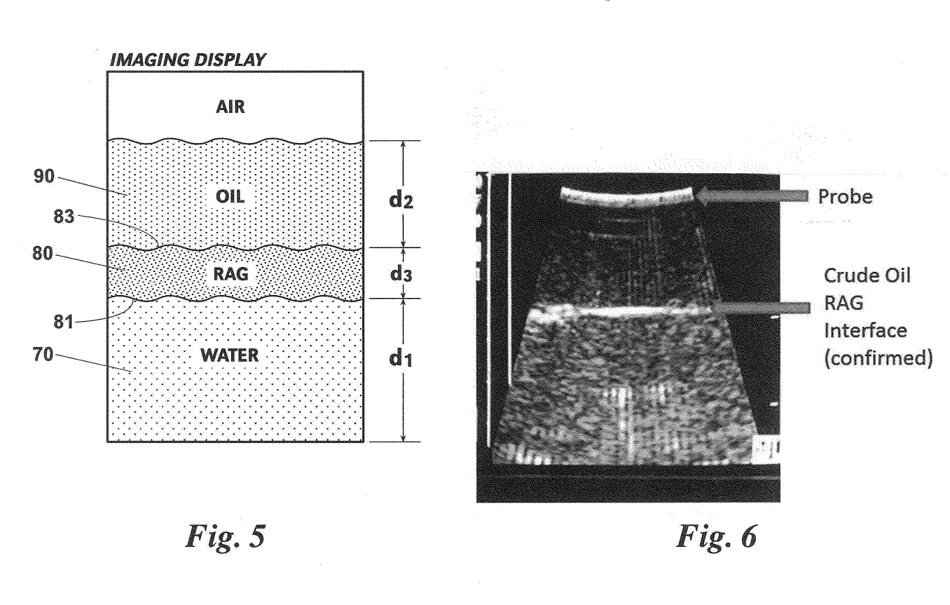

The reflectance at each interface—water-rag 81, rag-oil 83, oil-air—is converted into a brightness mode image using techniques known, for example, in the field of medical imaging. Using the brightness mode image, the layers 70, 80, 81, 83, 90 of the fluid (see FIG. 5) can be visually detected in real time (see e.g. FIG. 6).

What is claimed:

1. A method for determining the location of an interface emulsion layer within a separator vessel housing an oil-and-water mixture, the separator vessel being equipped with a plurality of transducer elements located at predetermined locations on the separator vessel to query fluid medium residing in different zones of the separator vessel and arranged oblique to a central longitudinal axis of the separator vessel, the method comprising the steps of:
sending a longitudinal wave at an ultrasonic frequency through the fluid medium, the longitudinal wave being sent by individual transducer elements of the plurality of transducer elements;
measuring for the individual transducer elements at least one of a pulse echo time and a reflected amplitude of the longitudinal wave;
using the measurements to determine a type of fluid medium residing within the different zones.

2. A method according to claim 1 wherein the using the measurements step includes a regression analysis to calculate at least one of a density and a viscosity of the type of fluid medium from at least one acoustic parameter selected from the group consisting of frequency, gain, and velocity of sound.

3. A system for determining the location of an interface emulsion layer within a separator vessel housing an oil-and-water mixture, the system comprising:
a first transducer oriented at a non-oblique angle to a central longitudinal axis of the separator vessel and arranged to send a first signal at an ultrasonic frequency across a first reference distance d₅, of a water-dominant portion of the separator vessel;
a second transducer oriented at a non-oblique angle to the central longitudinal axis of the separator vessel and arranged to send a second signal at an ultrasonic frequency across a second reference distance d₅, of an oil-dominant portion of the separator vessel;
a third transducer oriented at a non-oblique angle to a central longitudinal axis of the separator vessel and arranged to send a third signal at an ultrasonic frequency vertically upward through the water-dominant portion of the separator vessel and toward an interface emulsion layer;
a fourth transducer oriented at a non-oblique angle to a central longitudinal axis of the separator vessel and arranged to send a fourth signal at an ultrasonic frequency vertically downward through the oil-dominant portion of the separator vessel and toward an interface emulsion layer;
wherein:
the first signal provides a transit time t₅ across the first reference distance d₅ and is used in combination with the first reference distance d₅ to calculate a speed of sound c₁ through the water-dominant portion of the separator vessel;
the second signal provides a transit time t₆ of the second signal across the first reference distance d₅ and is used in combination with the first reference distance d₅ to a calculate a speed of sound c₂ through the oil-dominant portion of the separator vessel;
the third signal provides a pulse-echo transit time t₁ of the third signal and is used in combination with the speed of sound c₁ to calculate a distance d₁ to a lowermost end of the interface emulsion layer;
the fourth signal provides a pulse-echo transit time t₂ of the fourth signal and is used in combination with the speed of sound c₂ to calculate a distance d₂ to an uppermost end of the interface emulsion layer;
and wherein a height d₃ of the interface emulsion layer residing between the water-and oil-dominant portions is calculated using a second reference distance d₄ and the distances d₁ and d₂.

4. A system according to claim 3 wherein the ultrasonic frequency at which the first, second, third and fourth signals is transmitted is in a range of 40 kHz to 5 MHz.

5. A method for determining the location of an interface emulsion layer within a separator vessel housing an oil-and-water mixture, the method comprising the steps of:
sending a first signal at an ultrasonic frequency across a first reference distance d₅, of a water-dominant portion of the separator vessel;
measuring a transit time t₅ of the first signal across the first reference distance d₅; and
calculating, using the first reference distance d₅ and the transit time, t₅ a speed of sound c₁ through the water-dominant portion of the separator vessel;
sending a second signal at an ultrasonic frequency across a second reference distance d₅ of an oil-dominant portion of the separator vessel;
measuring a transit time t₆ of the second signal across the first reference distance d₅; and
calculating, using the first reference distance d₅ and the transit time t₆ a speed of sound c₁ through the oil-dominant portion of the separator vessel;
sending a third signal at an ultrasonic frequency vertically upward through the water-dominant portion of the separator vessel and toward an interface emulsion layer;
measuring a pulse-echo transit time, t₁, of the third signal; and
calculating, using the pulse-echo transit time t₁ and the speed of sound c₁, a distance, d₁ to a lowermost end of the interface emulsion layer;
sending a fourth signal at an ultrasonic frequency vertically downward through the oil-dominant portion of the separator vessel and toward an interface emulsion layer;
measuring a pulse-echo transit time, t₂, of the fourth signal; and
calculating, using the pulse-echo transit time t₂ and the speed of sound c₁, a distance d₁ to a lowermost end of the interface emulsion layer; and
calculating a height d₃ of the interface emulsion layer residing between the water-and oil-dominant portions using a second reference distance d₄ and the distances d₁ and d₂.

6. A method according to claim 5 wherein the ultrasonic frequency at which the first, second, third and fourth signals are transmitted is in a range of 40 kHz to 5 MHz.

7. A method according to claim 5 wherein the vessel is a vertically oriented vessel, the first and second signals are transmitted and received by at least one first and at least one second transducer respectively, each said transducer being oriented perpendicular to a central longitudinal axis of the vessel, and the third and fourth signals are transmitted and received by at least one third and at least one fourth transducer respectively, the third and fourth transducers being oriented parallel to the central longitudinal axis of the vessel.

8. A method according to claim 5 wherein the vessel is a horizontally oriented vessel, the first and second signals are transmitted and received by at least one first and at least one second transducer respectively, each said transducer being oriented parallel to a central longitudinal axis of the vessel, and the third and fourth signals are transmitted and received by at least one third and at least one fourth transducer respectively, the third and fourth transducers being oriented perpendicular to the central longitudinal axis of the vessel.

9. A system for determining the location of an interface emulsion layer within a separator vessel housing an oil-and-water mixture, the system comprising:
a plurality of transducers oriented at a non-oblique angle to a central longitudinal axis of the separator vessel and arranged at a vertical level L to send a signal at a predetermined ultrasonic frequency f_{L} and gain g_{L} across a horizontal reference distance d_{L} of the separator vessel;
a first transducer of the plurality located at a vertical level L₁ to send a first signal across a first horizontal reference distance d₁ of the separator vessel;
at least one second transducer of the plurality located at a vertical level L₂, L₂>L₁, to send a second signal across a second horizontal reference distance d₂;
a third transducer of the plurality located at a vertical level L₃, L₃>L₂, to send a third signal across a third horizontal reference distance d₃ of an upper portion of the separator vessel;
wherein:
the first signal provides a transit time t₁ across the first horizontal reference distance d₁ and is used in combination with the first horizontal reference distance d₁ to calculate a speed of sound c₁ through a fluid medium residing within the separator vessel at vertical level L₁;
the second signal provides a transit time t₂ of the second signal across the second horizontal reference distance d₂ and is used in combination with the second horizontal reference distance d₂ to a calculate a speed of sound c₂ through a fluid medium residing within the separator vessel at vertical level L₂;
the third signal provides a transit time t₃ of the third signal across the third horizontal reference distance d₃ and is used in combination with the third horizontal reference distance d₃ to calculate a speed of sound c₃ through a fluid medium residing within the separator vessel at vertical level L₁;
and wherein for a respective vertical level L_{L}, at least one of the calculated speeds of sound c_{L}, frequency f_{L}, and gain g_{L} is used in a regression equation to determine a density and a viscosity of the fluid medium residing at vertical level L, the density and viscosity of the interface emulsion layer being between that of an oil-dominant and a water-dominant portion of the separator vessel.

10. A system according to claim 9 wherein a frequency at which the first, second, and third signals are transmitted is in a range of 40 kHz to 5 MHz.

11. A method for determining the location of an interface emulsion layer within a separator vessel housing an oil-and-water mixture, the separator vessel equipped with a plurality of transducers oriented at a non-oblique angle to a central longitudinal axis of the separator vessel and arranged at a vertical level L to send a signal at a predetermined ultrasonic frequency f_{L} and gain g_{L} across a horizontal reference distance d_{L} of the separator vessel, the method comprising the steps of:
sending a first signal at a vertical level L₁ across a first horizontal reference distance d₁ of the separator vessel;
measuring a transit time t₁ of the first signal across the first horizontal reference distance d₁;
calculating, using the transit time t₁ and the first horizontal reference distance d₁, a speed of sound c₁ through a fluid medium residing within the separator vessel at vertical level L₁;
sending a second signal at a vertical level L₂, L₂>L₁, across a second horizontal reference distance d₂;
measuring a transit time t₂ of the first signal across the first horizontal reference distance d₂;
calculating, using the transit time t₂ and the first horizontal reference distance d₂, a speed of sound c₂ through a fluid medium residing within the separator vessel at vertical level L₂;
sending a third signal at a vertical level L₃, L₃>L₂, across a third horizontal reference distance d₃ of the separator vessel;
measuring a transit time t₃ of the first signal across the first horizontal reference distance d₃;
calculating, using the transit time t₃ and the first horizontal reference distance d₃, a speed of sound c₃ through a fluid medium residing within the separator vessel at vertical level L₃;
wherein for a respective vertical level L, at least one of the calculated speeds of sound c_{L}, frequency f_{L}, and gain g_{L} is used in a regression equation to determine a density and a viscosity of the fluid medium residing at vertical level L, the density and viscosity of the interface emulsion layer being between that of an oil-dominant and a water-dominant portion of the separator vessel.

12. A method according to claim 11 wherein level L₁ is located in a lower third of the separator vessel and the vertical level L₃ is located in an upper third of the separator vessel.

13. A method according to claim 11 wherein the frequency f_{L} is in a range of 40 kHz to 5 MHz.

14. A system for determining the location of an interface emulsion layer within a separator vessel housing an oil-and-water mixture, the system comprising:
a phased array located at a top or bottom side of the separator vessel, the phased array including a plurality of spaced-apart individual transducer elements, each individual transducer element emitting an ultrasonic signal at a different predetermined time delay per angle within a field of view of the phased array;
wherein the ultrasonic signal is reflected as it encounters an interface between fluid mediums residing within the separator vessel; and
wherein the reflectance amplitude of the ultrasonic signal is converted to a brightness image, a brightness image of the interface emulsion layer being different than that of an oil-dominant and a water-dominant layer.

15. A system according to claim 14 wherein the field of view is 120°.

16. A system according to claim 14 wherein a frequency at which the ultrasonic signal is transmitted is in a range of 40 kHz to 5 MHz.

17. A method for determining the location of an interface emulsion layer within a separator vessel housing an oil-and-water mixture, the separator vessel being equipped with a phased array of individual transducer elements located at a top or a bottom side of the separator vessel, the method comprising the steps of:
sending from the individual transducer elements an ultrasonic signal at a predetermined angle φ, the sending step occurring at a different time t for each individual transducer element;
measuring for each respective individual transducer element, an amplitude of a reflected signal at a water-rag interface and at a rag-oil interface
incrementing the predetermined angle φ through a field of view of the phased array and for each incremented predetermined angle φ repeating the sending and measuring steps; and
converting the measured amplitudes of the reflected signals into a brightness image.

18. A method according to claim 17 wherein the sending step the individual transducer element is delayed sequentially by τₙ=(n−1)×Δ, where Δ is a function of the angle φ and n is the sequential order number associated with an individual transducer element in the phased array.

19. A method according to claim 17 wherein the field of view is 120°.

20. A method according to claim 17 wherein a frequency at which the first and second ultrasonic signals are transmitted is in a range of 40 kHz to 5 MHz.

21. A method according to claim 17 further comprising the step of measuring a visual separation of at least one of the oil, rag, and water layers.

22. A method according to claim 21 wherein digital calipers measure the visual separation.

23. A method according to claim 17 wherein real time depletion of a rag layer is visual after chemical solvents have been added to the separator vessel.

24. A method according to claim 17 further comprising the step of displaying the brightness image.
